(19) United States
(12) Patent Application Publication
(10) Pub. No.: US 2016/0044382 A1
(43) Pub. Date: Feb. 11, 2016

(54) DISPLAY DEVICE AND METHOD FOR OPERATING THE SAME

(71) Applicant: LG ELECTRONICS INC., Seoul (KR)

(72) Inventors: Seokwon SEO, Seoul (KR); Yeram CHOI, Seoul (KR); David KEMPE, Santa Clara, CA (US); Keith WENG, Santa Clara, CA (US); Guennadi NARYCHKINE, Santa Clara, CA (US)

(73) Assignee: LG ELECTRONICS INC., Seoul (KR)

(21) Appl. No.: 14/566,839

(22) Filed: Dec. 11, 2014

(30) Foreign Application Priority Data
Aug. 8, 2014 (KR) 10-2014-0102069

(51) Int. Cl. H04N 21/485; H04N 21/41; H04N 21/4722; H04N 21/478; H04N 21/81; H04N 21/643

(52) U.S. Cl. CPC H04N 21/4858; H04N 21/8173; H04N 21/8126; H04N 21/64322; H04N 21/4722; H04N 21/4781; H04N 21/47815; H04N 21/4126

(57) ABSTRACT

A display device according to an embodiment is connected to an external device, and displays an icon of a related application on a first page of a display unit when a user sets an external device. Furthermore, when a plurality of external devices are connected to the display device, the display device determines a priority order of the external devices so as to display icons of related applications according to the priority order.

### CROSS-REFERENCE TO RELATED APPLICATIONS

The present application claims priority under 35 U.S.C. 119 and 35 U.S.C. 365 to Korean Patent Application No. 10-2014-0102069 (filed on Aug. 8, 2014), which is hereby incorporated by reference in its entirety.

### BACKGROUND

The present disclosure relates to a display device and a method for operating the same, and more particularly, to a display device for automatically arranging applications according to a setting of an external device and a method for operating the same.

A digital TV service using a wired or wireless communication network has recently become common. The digital TV service may provide various services that a conventional analog broadcasting service is unable to provide.

For example, an Internet protocol television (IPTV) service which is a type of the digital TV service provides interactivity so as to enable a user to actively select a program type, a viewing time, etc. Based on the interactivity, the IPTV service may provide various additional services such as an Internet search service, a home shopping service, an online game service and the like.

Furthermore, recent smart TVs provide user interface screens for providing various information to users. In detail, such smart TVs provide new user interfaces based on an operating system (OS) to users. Although OS-based application arrangement is optimized for smart TVs, the number of applications displayed at once on a screen is limited in consideration of readability and practicality.

According to the related art, since applications are uniformly arranged without considering information on an external device that is frequently used by a user, the user should turn pages of an application to control the external device via a smart TV and thus may experience inconvenience.

### SUMMARY

According to various embodiments, an application is automatically arranged according to an external device set by a user so that the user efficiently controls functions of a display device.

According to an embodiment, when there exist a plurality of external devices set by the user, related applications are automatically arranged according to a priority order so that the user efficiently controls the functions of the display device.

Furthermore, according to an embodiment, the user may arrange an application related to a set external device with preference over a premium application arranged on an initial screen.

Moreover, according to an embodiment, the number of times of setting of each external device by the user is counted so that an image display device automatically determines the priority order in order to arrange related applications.

In one embodiment, a method for operating a display device includes displaying an initial screen including a plurality of icons corresponding to a plurality of applications respectively, detecting at least one external device, receiving, from the external device, a setting completion signal indicating that setting of the detected external device is completed, and displaying an external device icon corresponding to the external device on the initial screen according to the setting completion signal.

### BRIEF DESCRIPTION OF THE DRAWINGS

FIG. 1 is a block diagram illustrating relations among a display device, a network operator and a content provider according to an embodiment.

FIG. 2 is a block diagram illustrating the display device according to an embodiment.

FIG. 3 is a block diagram illustrating a broadcast receiving device capable of processing a 3D image according to an embodiment.

FIGS. 4 and 5 illustrate an example of a remote controller for controlling the display device of FIG. 2 or 3.

FIG. 6 is a block diagram illustrating an interface unit of the display device of FIG. 1 and the motion recognizing remote controller of FIG. 4.

FIG. 7 illustrates a menu screen of the display device according to an embodiment.

FIGS. 8 and 9 illustrate a method of implementing the menu screen including a background image and icons according to an embodiment.

FIG. 10 illustrates that a screen displays information indicating that a network interface does not operate.

FIG. 11 is a flowchart illustrating a method of displaying a video according to an icon selected from the menu screen including the background image and the icons according to an embodiment.

FIG. 12 illustrates an operation for a recent list of UX of the display device.

FIG. 13 illustrates a home screen of the UX of the display device.

FIG. 14 illustrates a launcher screen of the UX of the display device.

FIG. 15 illustrates a process of booting the display device.

FIG. 16 illustrates an overall configuration of the home screen.

FIG. 17 illustrates that a content provider application which is a type of a general application is installed.

FIG. 18 illustrates that a current display application is controlled on the home screen.

FIG. 19 illustrates an overall configuration of the recent list screen.

FIG. 20 illustrates that the recent list is deleted.

FIG. 21 illustrates a screen on which the recent list does not exist.

FIG. 22 illustrates an overall configuration of the launcher screen.

FIG. 23 illustrates a method of moving an icon in a 5-way mode.

FIG. 24 illustrates a method of deleting an icon in the 5-way mode.

FIG. 25 illustrates a method of moving an icon in a pointer mode.

FIG. 26 illustrates a method of deleting an icon in the pointer mode.

FIG. 27 illustrates the display device, the remote controller and an external device according to an embodiment.

FIG. 28 is a flowchart illustrating a process of changing a location of a related icon according to connection of the external device.

FIG. 29 is a diagram illustrating that a control unit automatically forward arranges an icon related to the use of the external device.

FIG. 30 is a flowchart illustrating a process of arranging icons of applications when a plurality of external devices are connected simultaneously to the display device.

FIG. 31 illustrates that icons are arranged according to a priority order when the plurality of external devices are connected.

FIG. 32 illustrates that a user arranges applications of the external devices with preference over premium applications.

### DETAILED DESCRIPTION OF THE EMBODIMENTS

Hereinafter, embodiments will be described in detail with reference to the accompanying drawings. In the following description, the terms “module” and “unit” for referring to elements are assigned thereto and used exchangeably for convenience, and thus, the terms per se do not necessarily represent different meanings or functions.

A display device 30 according to an embodiment, which is, e.g., an intelligent display device having both a broadcast receiving function and a computer support function, is devoted to the broadcast receiving function but also has an Internet search function, so that easy-to-use interfaces such as a handwriting-type input device, a touch screen, or a spatial remote controller may be provided. Furthermore, with a wire/wireless Internet function, the intelligent display device may be connected to the Internet and a computer, so that functions such as electronic mail sending, web browsing, banking, or gaming may be performed. For such various functions, a standardized general OS may be used.

Therefore, various user-friendly functions may be performed in the display device 30 described herein since various applications are allowed to be freely added to or deleted from a general OS kernel. For example, the display device 30 may be a network TV, an HBBTV, a smart TV, an LED TV, or an OLED TV, or may be applied to a smartphone.

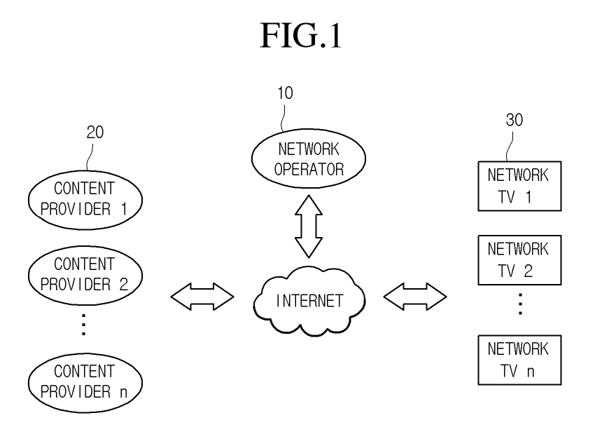

FIG. 1 is a block diagram illustrating relations among the display device 30, a network operator 10 and a content provider (CP) 20.

Referring to FIG. 1, a system for a display device according to an embodiment may include the network operator 10, at least one content provider 20 and at least one display device 30 which are connected to each other by a network, e.g., the Internet.

The network operator 10 provides, to the display device 30, basic software required for multiple pieces of content provided by the content provider 20 to be played normally in the display device 30 or software required for the display device 30 to be operated. Furthermore, the network operator 10 provides, to the content provider 20, hardware information of the display device 30 required for content to be played normally in the display device 30.

For example, the network operator 10 provides a basic screen frame required to provide multiple pieces of content provided by the content providers to the display device 30, and provides a user interface required for a user to select content or input various commands or required to display an output according thereto. Furthermore, the network operator 10 serves to provide data for updating firmware or software of the display device 30. The network operator 10 may be the same as a manufacturer of the display device 30.

The content provider 20 generates various pieces of content able to be provided in a network and configures the pieces of content in formats supported by the display device 30 so as to provide the pieces of content in response to a request of the display device 30. Content according to an embodiment may be any multimedia content that may be provided via a network.

According to an embodiment, the content of the content provider 20 may be directly provided to the display device 30 by the content provider 20 via the internet, or may be provided to the display device 30 via the network operator 10.

Dedicated firmware for playing or retrieving content or displaying a list of content for each content provider 20 may be installed in the display device 30. The firmware may be installed in the display device 30 while the display device 30 is manufactured, or may be downloaded by a user from the content provider 20 or the network operator 10 so as to be installed.

The firmware of the display device 30 may be a program for playing or executing the content provided by the content provider 20. The firmware may be different according to the type of the content provided by the content provider 20. For example, in the case where the content provider 20 is a video on demand (VOD) provider, the firmware may be a VOD playback program. In the case where the content provider 20 is an audio on demand (AOD) or music on demand (MOD) provider, the firmware may be an AOD or MOD playback program. In the case where the content provider 20 is a video call provider, the firmware may be a video call program.

The display device 30 may receive content from the content provider 20 so as to play or execute the received content. The display device 30 according to an embodiment includes a TV equipped with a network module, a broadcast receiving device such as a set-top box, and any display device equipped with a network module such as a telephone for a network. Although the broadcast receiving device is exemplarily described herein, the embodiments of the present disclosure may be applied to any display device capable of accessing a network, and all the embodiments fall within the scope of the present disclosure.

In detail, the content provider 20 may be a business operator for creating or distributing various pieces of content to be provided to the display device 30. The content provider 20 may be a TV broadcasting station, a radio broadcasting station, a VOD provider, an AOD provider, a game provider, a video call service provider, a weather information provider and a picture-related service provider.

The TV broadcasting station represents an existing terrestrial broadcasting station or cable broadcasting station. Such a broadcasting station may produce and store programs to be viewed by users, and may digitize the programs so as to transmit the programs.

The radio broadcasting station may provide audio content alone or together with video content.

The VOD provider and the AOD provider provide services having different characteristics from those of services provided by the TV broadcasting station or the radio broadcasting station. That is, VOD or AOD services allow a user to store broadcast programs, movies or music so that the user may play the programs, movies or music later. For example, if the user desires to view a broadcast program missed due to circumstances, the user may access a website that provides such a broadcasting service and may download or directly play a corresponding file.

The AOD provider provides an audio content streaming service.

The MOD provider allows the user to download and listen to music.

The video call provider provides a relay service so that the user makes a video call to a user of another display device via a network. The weather information provider provides weather information of various areas, and the picture-related service provider provides a tool for editing and storing pictures.

In addition, the content provider 20 may be any server operator capable of providing various services to a display device via the Internet, such as a packet filter (PF) server, an electronic program guide (EPG) service provider, an electronic content guide (ECG) service provider and a portal server operator.

The PF server is operated by an agency that manages all of broadcast information and location information provided by a content provider. The service provided by the PF server contains broadcasting information of a corresponding broadcasting station, location information required for broadcasting and information for allowing access of the user.

The EPG service provides EPG information so that the user refers to broadcast programs for each time slot and detects the broadcast programs for each channel.

The ECG service provides, to the user, information on content of a content provider, location information of an access server, and an access right. That is, this service provides an electronic guide for enabling the user to easily access servers having content and for informing of detailed information of the content.

The portal server, which provides web services of broadcasting stations, connects a user terminal to a web server of a broadcasting station or a content provider upon receiving a request from the user terminal. The portal server serves to allow the user to search for a program list provided by broadcasting stations or content providers.

The display device 30 basically has a network interface for accessing a network, and is assigned an IP address so as to receive and process data packets from a network. Here, in the case where the data packets are multimedia data such as a video or an audio, the display device 30 may store or play the data packets.

The display device 30 may be operated to interactively transmit a request of the user, while processing the multimedia data. Furthermore, a user input unit such as a remote controller or a manipulation button may be provided with buttons for controlling the display device, i.e., buttons for selecting various menus.

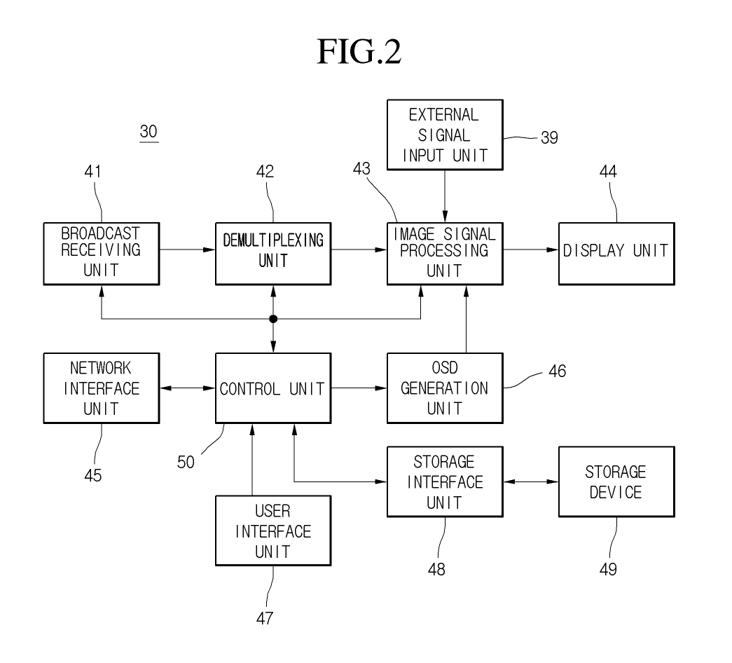

A configuration and an operation of the display device will be described in detail. FIG. 2 is a block diagram illustrating the display device 30 according to an embodiment.

The display device 30 may have a function of receiving RF-type broadcast signals wirelessly or through a cable using a broadcast receiving unit 41, in addition to a function of receiving content via a network.

As illustrated in FIG. 2, the display device 30 according to an embodiment includes the broadcast receiving unit 41, a demultiplexing unit 42, an image signal processing unit 43, a display unit 44, a network interface unit 45, an OSD generation unit 46, a user interface unit 47, a storage interface unit 48, a storage device 49, an external signal input unit 39 and a control unit 50.

The broadcast receiving unit 41, the demultiplexing unit 42 and the image signal processing unit 43 may form a single broadcast processing unit for receiving and processing broadcast signals so that the broadcast signals have such a format as to be output to the display unit 44.

In the case where content is a digital broadcast, a digital broadcast signal is transmitted in the form of a transport stream in which a video signal, an audio signal and additional data are time-division multiplexed and packetized.

The broadcast receiving unit 41 may include an antenna for receiving a broadcast signal transmitted from the outside, a tuner for tuning a broadcasting signal having a corresponding frequency band according to a tuning control signal, and a demodulator (demodulation unit) for outputting a tuned broadcast signal of a specific channel in the form of a transport stream through a vestigial sideband (VSB) demodulation process and an error correction process.

The broadcast signal received by the broadcast receiving unit 41 is divided by the demultiplexing unit 42 into a video signal, an audio signal and various additional data defined by program and system information protocol (PSIP) information so as to be output in the form of a bit stream.

The video data separated by the demultiplexing unit 42 is processed by the image signal processing unit 43 so as to be displayed on the display unit 44.

Here, the image signal processing unit 43 includes an MPEG-2 decoder and a scaler for converting the video data so that the video data has a vertical frequency, resolution and a screen ratio matched to an output standard of the display unit 44.

Here, various types of displays, such as a digital light processing (DLP) display, a liquid crystal display (LCD) and a plasma display panel (PDP), may be used as the display unit 44.

The audio signal is processed by a sound signal processing unit (not illustrated) so as to be output through a speaker, wherein the sound signal processing unit may include an AC-3 decoder.

Meanwhile, the additional data separated by the demultiplexing unit 42 is stored in the storage device 49 via the storage interface unit 48.

The storage device 49 may be implemented with an electrically erasable programmable read-only memory (EEPROM).

The user interface unit 47, which serves to receive a request command from the user, includes an infrared receiving unit for receiving an infrared signal input through a remote controller or a local key input unit provided to a side of a panel.

The network interface unit 45 receives content or data from the content provider or the network operator 10 via a network. That is, the network interface unit 45 receives, via the network, content such as a broadcast, a game, a VOD or a broadcast signal provided by the content provider and information related to the content. Furthermore, firmware update information and an update file provided by the network operator 10 are received through the network interface unit 45.

The OSD generation unit 46 generates a menu screen for receiving a determination signal of the user in the form of an on screen display (OSD).

That is, the OSD generation unit 46 may display, on the display unit, the content-related information received through the network interface unit 45.

The external signal input unit 39 is an interface for receiving an input from another playback device, for example, a DVD player or a game machine. The other playback device may be connected to the external signal input unit 39 so that multimedia content stored in the playback device is output to the display unit 44.

The control unit 50 performs an overall control operation according to a command received from the user interface unit 47. The control unit 50 receives and executes the software of the content provider 20 received from the network operator 10, i.e., the firmware update file.

According to an embodiment, the broadcast receiving device 40 may output a 3D image. The broadcast receiving device 40 may provide a menu screen three dimensionally, and may also receive 3D content provided by the content provider 20 to output the 3D content.

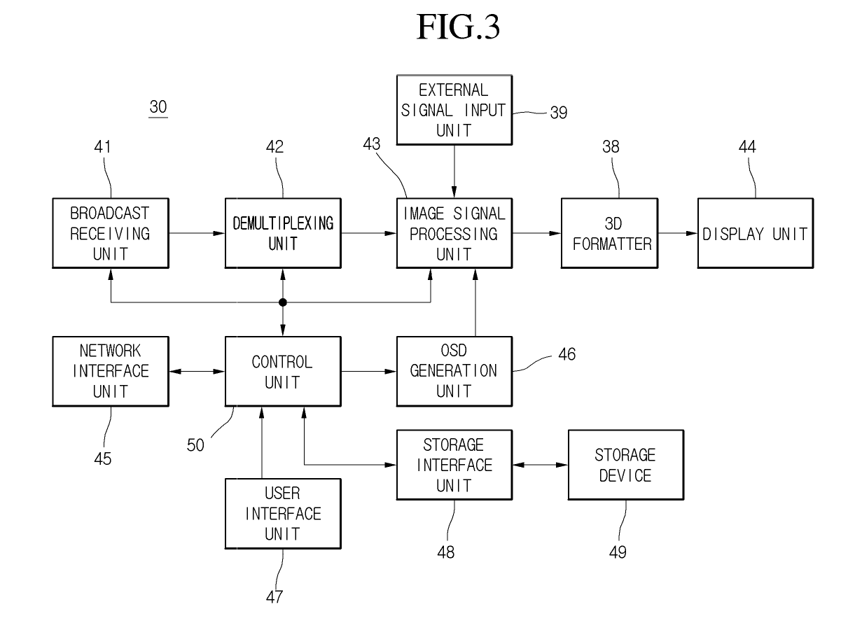

Additional elements may be necessary to output 3D images. FIG. 3 is a block diagram illustrating a broadcast receiving device capable of processing a 3D image according to an embodiment. The elements of the broadcast receiving device, excepting a 3D formatter 38, are operated in the same manner as described above with reference to FIG. 2.

As illustrated in FIG. 3, the 3D formatter 38 is arranged at an output terminal of the image signal processing unit 43. The 3D formatter 38 converts an image processed by the image signal processing unit 43 into a 3D image to transfer the 3D image to the display unit 44. According to an embodiment, an additional 3D formatter for three-dimensionally converting an OSD output may be arranged in the OSD generation unit 46.

The configuration illustrated in FIG. 3 is merely an example, and various well-known technologies may be used to process 3D images.

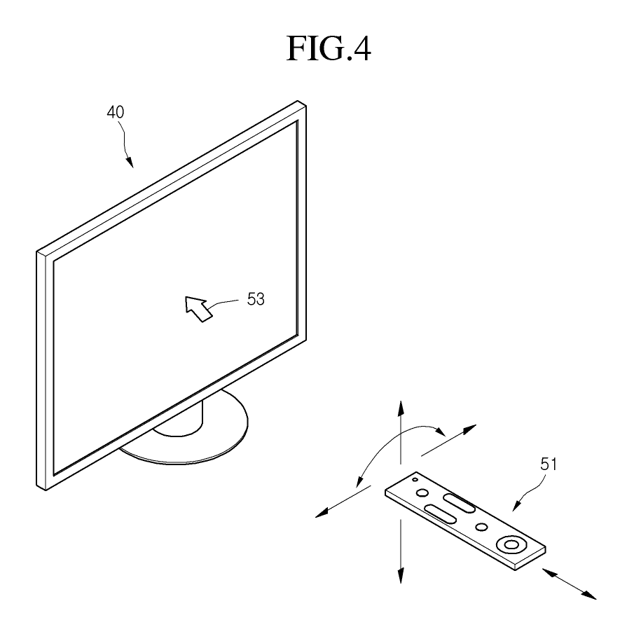

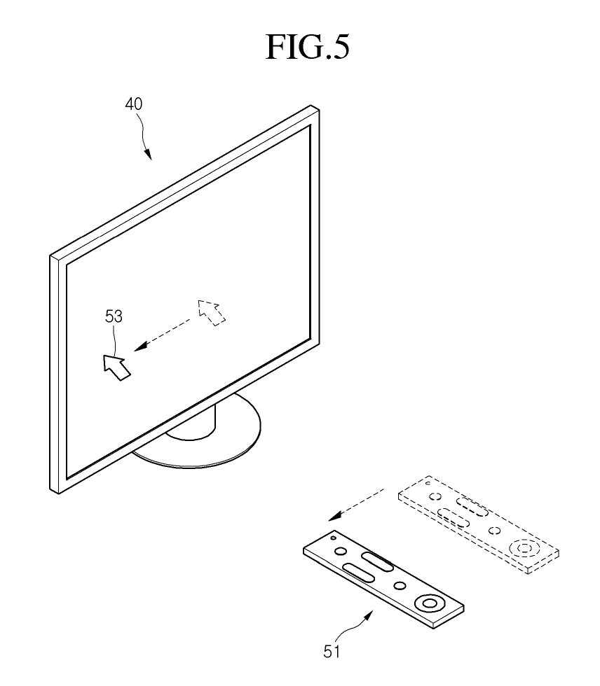

FIGS. 4 and 5 illustrate an example of the remote controller 51 for controlling the display device 30 of FIG. 2 or 3. The remote controller 51 may transfer a control signal to the control unit 50 via a unit for receiving a wireless signal such as an RF signal or an infrared signal, which may be included in the user interface 47 of the display device 30. The remote controller device 51 described with reference to FIGS. 4 to 6 responds to not only a button input of the user but also a gesture of the user, and is referred to as a motion recognizing remote controller 51 below.

In the present embodiment, the motion recognizing remote controller 51 may exchange signals with the display device 30 according to an RF communication standard. As illustrated in FIG. 4, a pointer 53 may be displayed on the display device 30 at a point pointed by the motion recognizing controller 51.

The user may move the motion recognizing remote controller 51 vertically, horizontally or back and forth or may rotate the motion recognizing remote controller 51. The pointer 53 displayed on the display device 30 corresponds to a motion of the motion recognizing remote controller 51. FIG. 5 illustrates that the pointer 53 displayed on the display device 30 moves in response to the motion of the motion recognizing remote controller 51.

As illustrated in FIG. 4, if the user moves the motion recognizing remote controller 51 leftward, the pointer 53 displayed on the display device 30 moves leftward. In the present embodiment, the motion recognizing remote controller 51 may be provided with a sensor for recognizing a motion. Information on the motion of the motion recognizing remote controller 51 detected by the sensor of the remote controller 51 is transmitted to the display device 30. The display device 30 discriminates the motion of the motion recognizing remote controller 51 on the basis of the information on the motion of the motion recognizing remote controller 51, and calculates coordinates of the pointer 53 corresponding to the motion of the motion recognizing remote controller 51.

An acceleration sensor, a gyro sensor or a geomagnetic sensor may be used as the sensor for recognizing a motion.

FIGS. 4 and 5 illustrate that the pointer 53 displayed on the display device 30 is moved in response to the vertical or horizontal movement or rotation of the motion recognizing remote controller 51. A moving speed or a moving direction of the pointer 53 may correspond to a moving speed or a moving direction of the motion recognizing remote controller 51.

In the present embodiment, the pointer 53 displayed on the display device 30 moves in response to the motion of the motion recognizing remote controller 51. In another embodiment, a predetermined command may be input to the display device 30 in response to the motion of the motion recognizing remote controller 51. For example, when the motion recognizing remote controller 51 is moved back and forth, an image displayed on the display device 30 may be magnified or reduced.

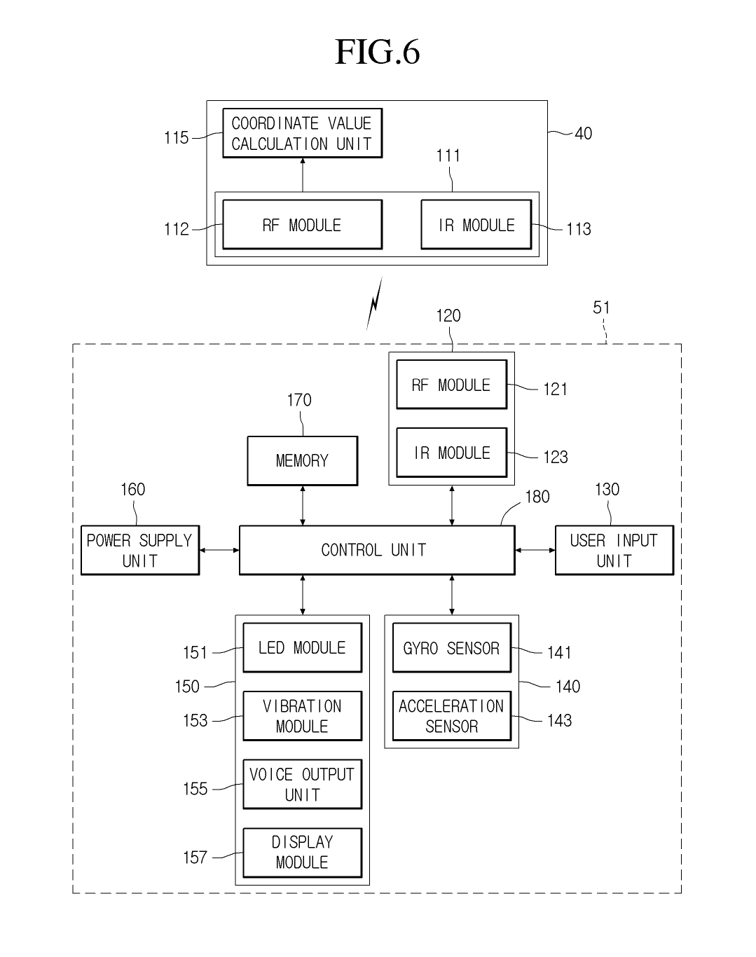

FIG. 6 is a block diagram illustrating the interface unit 47 of the display device 30 of FIG. 1 and the motion recognizing remote controller 51 of FIG. 4.

Referring to FIG. 6, the display device 30 may include a coordinate value calculation unit 115 and a wireless communication unit 111. The coordinate value calculation unit 115 may be included in the control unit 50. The wireless communication unit 111 may be included in the user interface unit 47. The wireless communication unit 111 may include an RF module 112 or an IR module 113.

The motion recognizing remote controller 51 may include a wireless communication unit 120, a user input unit 130, a sensor unit 140, an output unit 150, a power supply unit 160, a memory 170 and a control unit 180.

The wireless communication unit 120 transmits/receives signals to/from the display device 30. In the present embodiment, the motion recognizing remote controller 51 may be provided with an RF module 121 so as to transmit/receive signals to/from the interface unit 40 of the display device 30 according to an RF communication standard. Furthermore, the motion recognizing remote controller 51 may be provided with an IR module 123 so as to transmit/receive signals to/from the interface unit 40 of the display device 30 according to an IR communication standard.

In the present embodiment, the motion recognizing remote controller 51 transmits a signal containing information on the motion of the motion recognizing remote controller 51 to the display device 30 via the RF module 121. The motion recognizing remote controller 51 may receive, via the RF module 121, signals transmitted by the display device 30. Furthermore, the motion recognizing remote controller 51 may transmit, as necessary, a command for turning on/off power, changing a channel or adjusting a volume to the display device 30 via the IR module 223.

The user input unit 130 may include a keypad or a button. The user may manipulate the user input unit 130 so as to input a command related to the display device 30 to the motion recognizing remote controller 51. In the case where the user input unit 130 is provided with a hard key button, the user may input the command related to the display device 30 to the motion recognizing remote controller 51 by pushing the hard key button. In the case where the user input unit 130 is provided with a touchscreen, the user may input the command related to the display device 30 to the motion recognizing remote controller 51 by touching a soft key on the touchscreen. Furthermore, the user input unit 130 may be provided with various input units to be manipulated by the user, such as a scroll key and a jog key, but the present disclosure is not limited thereto.

The sensor unit 140 may include a gyro sensor 141 or an acceleration sensor 143 as a motion sensor. The gyro sensor 141 may detect a movement of the motion recognizing remote controller 51. For example, the gyro sensor 141 may sense information on the movement of the motion recognizing remote controller 51 with respect to x, y and z axes. The acceleration sensor 141 may sense information on the moving speed of the motion recognizing remote controller 51. The output unit 150 may output an image or sound signal corresponding to manipulation on the user input unit 130 or a signal transmitted from the display device 30. The user may recognize whether the user input unit 130 is manipulated or the display device 30 is controlled, by means of the output unit 150.

For example, the output unit 150 may be provided with an LED module 151, a vibration module 153, a voice output module 155 or a display module 157 which emit light, generate vibration, output a voice or output an image when the user input unit 130 is manipulated or a signal is transmitted/received to/from the display device 30 via the wireless communication unit 120.

The power supply unit 160 supplies power to the motion recognizing remote controller 51. The power supply unit 160 may block the supply of power when the motion recognizing remote controller 51 does not move for a predetermined period of time. The power supply unit 160 may resume the supply of power when a predetermined key of the motion recognizing remote controller 51 is manipulated.

The memory 170 may store various types of application data required for controlling or operating the motion recognizing remote controller 51. In the case where the motion recognizing remote controller 51 wirelessly transmits/receives signals to/from the display device 30 via the RF module 121, the motion recognizing remote controller 51 and the display device 30 transmit/receive signals at a predetermined frequency band. The control unit 180 of the motion recognizing remote controller 51 may store, in the memory 170, information on a frequency band at which signals are able to be transmitted/received to/from the display device 30 paired with the motion recognizing remote controller 51, and may refer to the information.

The control unit 180 controls overall control operation of the motion recognizing remote controller 51. The control unit 180 may transmit a signal corresponding to manipulation on a predetermined key of the user input unit 130 or a signal corresponding to the motion of the motion recognizing remote controller 51 sensed by the sensor unit 140 to the wireless communication unit of the display device 30 via the wireless communication unit 120.

As described above, the display device 30 may be provided with the wireless communication unit 120 for wirelessly transmitting/receiving signals to/from the motion recognizing remote controller 51 and the coordinate value calculation unit 115 for calculating a coordinate value of the pointer 53 corresponding to the motion of the motion recognizing remote controller 51.

The wireless communication unit 111 may wirelessly transmit/receive signals to/from the motion recognizing remote controller 51 via the RF module 112. Furthermore, the wireless communication unit 111 may receive a signal transmitted by the motion recognizing remote controller 51 via the RF module 112 according to the IR communication standard.

The coordinate value calculation unit 115 may compensate hand shaking or an error with respect to a signal corresponding to the motion of the motion recognizing remote controller 51 and received via the wireless communication unit 111, so as to calculate x and y coordinate values of the pointer 53 to be displayed on the display device 30.

Furthermore, the signal transmitted from the motion recognizing remote controller 51 and input to the display device 30 via the interface unit 40 is transmitted to the control unit 50 of the display device 30. The control unit 50 may recognize information on an operation and key manipulation of the motion recognizing remote controller 51 from the signal transmitted from the motion recognizing remote controller 51, and may control the display device 30 according to the information.

Hereinafter, a menu screen of the display device 30 and a manipulation method thereof according to an embodiment will be described.

The “menu screen” of the display device 30 according to an embodiment is an initial screen or a main screen provided when the display device 30 enters a menu providing operation mode (hereinafter referred to as a netcast mode) in which one of a plurality of content providers is allowed to be selected so as to be accessed. The menu screen may include a plurality of icons 212 indicating the plurality of content providers, and may also include a background image 201 having a specific theme according to an embodiment.

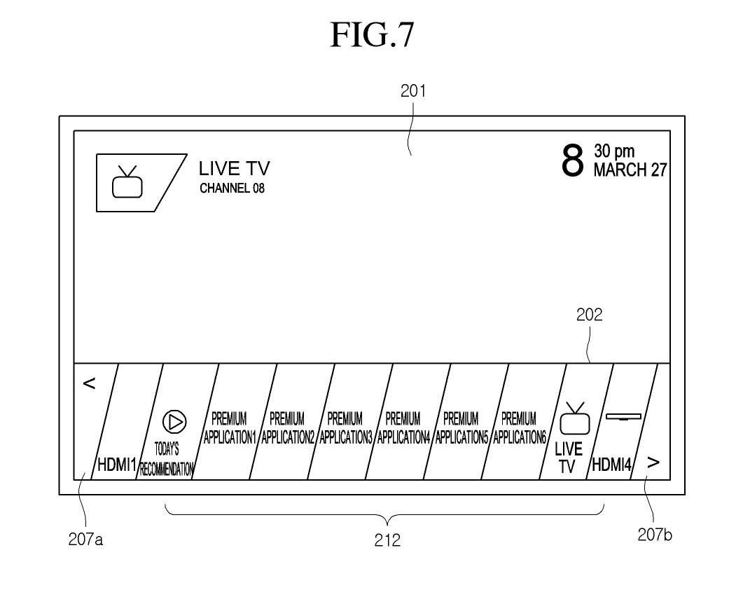

FIG. 7 illustrates the menu screen of the display device 30 according to an embodiment.

An image of which the theme is a city is used as the background image 201 of the menu screen of FIG. 7, and the icons 212 are displayed on the background image 201. The background image 201 of the menu screen may have various themes in addition to a city, such as a jungle, a department store, a beach, space and a scene of a fairy tale. The background image 201 may include graphic objects so that a basic image matched to a theme and other images may be selectively inserted and displayed.

The icons 212 are buttons for accessing servers of the plurality of content providers. The user may select one of the icons 212 so as to access a server of a selected content provider and receive a desired service. Preferably, the icons 212 may be related to the background image 201. That is, the icons 212 may include graphic objects matched to the background image 212. For example, as illustrated in FIG. 7, the icons 212 may be displayed in the form of a structure or a billboard standing on a street. Images displayed on the icons 212 may be provided by each content provider.

When the background image 201 is changed according to user information, for example, a location, the icons 212 or the images displayed thereon may also be changed.

The user may use the motion recognizing remote controller 51 described above with reference to FIGS. 4 to 6 in order to select the icons 212.

According to an embodiment, in addition to the above-mentioned icons, various types of icons may be displayed on the menu screen. Scroll bars 207a and 207b may be arranged at the left and right of the icons 212 so that additional icons may be displayed when the scroll bar 207 or 207b is selected by the user.

When the user selects one of the icons 212, for example, a netfly icon 204, the selected icon 204 is highlighted so as to be distinguished from the other icons. If an arrow button of the motion recognizing remote controller 51 is manipulated or another icon is selected while the selected icon 204 is highlighted, the highlight may be moved to the other icon selected. If an ENTER button of the motion recognizing remote controller 51 or another button having a function corresponding to the ENTER button is pushed while an icon is selected, a server of a content provider corresponding to the selected icon is accessed and an initial screen of the server of the content provider is displayed.

The number, size or arrangement of the icons displayed on one screen may be changed according to an embodiment.

The icons 212 may have titles or images for identifying each content provider, and may be preinstalled in the display device 30 by a manufacturer of the display device 30. Furthermore, according to an embodiment, while the user uses the display device 30, the network operator 10 of FIG. 1 may receive an image to be used as an icon from the content provider 20 to transmit the image to the display device 30 or provide an update thereto. Alternatively, the display device 30 may directly access the server of the content provider 20 to download the image.

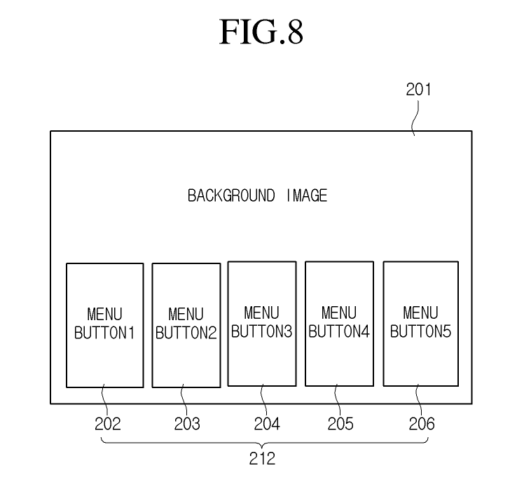

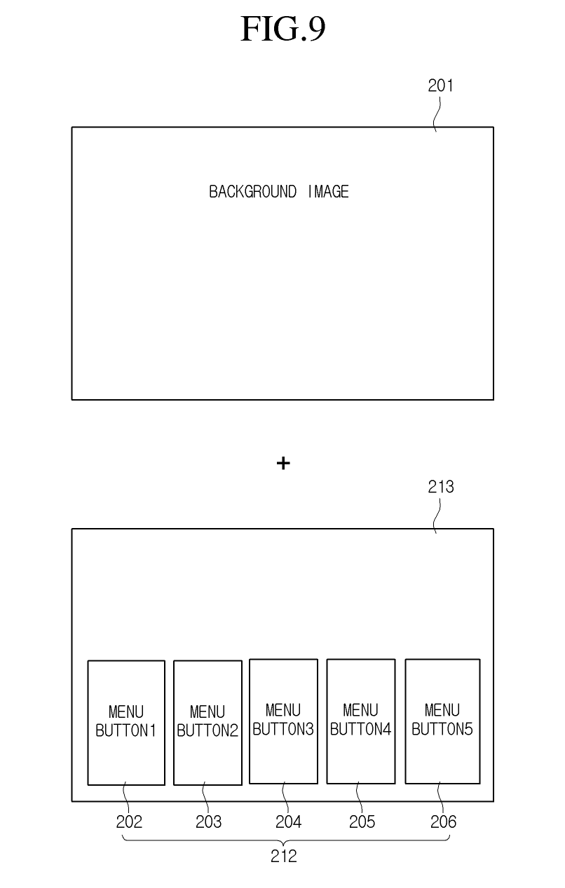

FIGS. 8 and 9 illustrate a method of implementing the menu screen including the background image 201 and the icons 212 according to an embodiment.

As illustrated in FIG. 9, the menu screen according to an embodiment may include the background image 201 and the icons 212 arranged thereon. As illustrated in FIG. 9, the menu screen may be implemented by overlapping a layer 213 including the background image 201 and a layer 213′ including the icons.

According to an embodiment, different effects may be provided to the layers 213 and 213′. For example, only the icons 212 may be displayed semi-transparently, or only the background image 201 may be displayed semi-transparently.

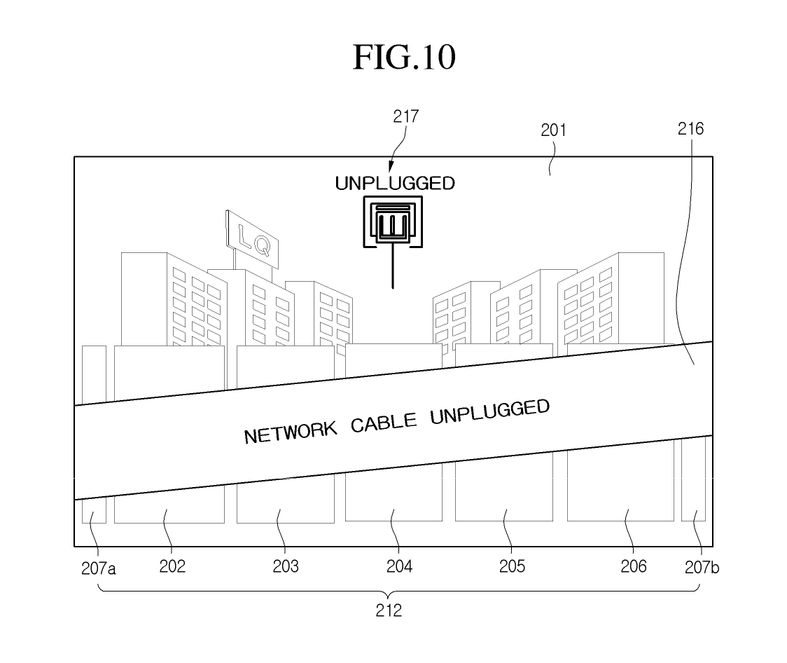

FIG. 10 illustrates that a screen displays information indicating that a network interface does not operate.

According to an embodiment, if a network cable of the display device 30 is unplugged and thus the network interface does not operate when the user executes the netcast mode, this state may be displayed over the menu screen as illustrated in FIG. 10. Here, as illustrated in FIG. 10, this state may be displayed using an off-limits sign tape 216 of a typical construction site and an arbitrary graphic image 217 indicating that the network cable is unplugged rather than using a typical text, so that the user may intuitively recognize the state with amusement.

Here, since a netcast service of the display device 30 is unavailable, the images on the menu screen other than the indicators 216 and 217, i.e., the background image 201 and the icons 212, are displayed semi-transparently or blurredly so that the user may more intuitively apprehend the state.

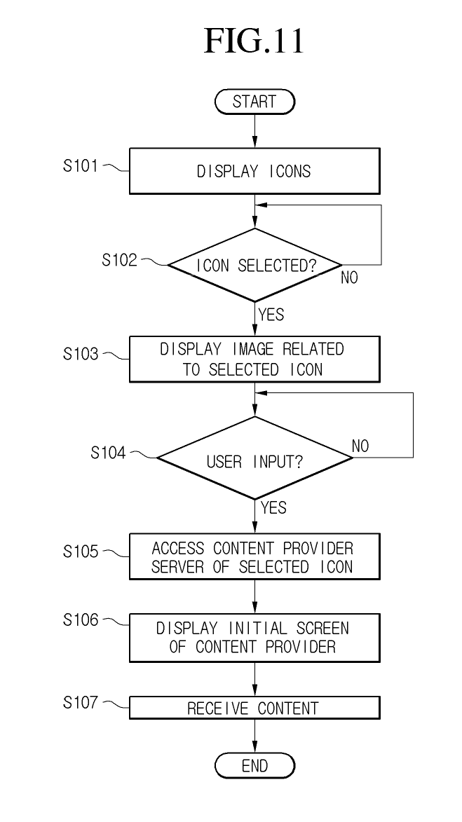

FIG. 11 is a flowchart illustrating a method of displaying a video according to an icon selected from the menu screen including the background image 201 and the icons 212 according to an embodiment.

In operation S101, the menu screen including the icons indicating the content providers is displayed. The background image may be displayed together with the icons. In operation S102, the user is allowed to select one of the icons. If there is no input from the user, an input from the user is continuously awaited.

In operation S103, an image related to the icon selected by the user is displayed, while the background image and the icons are displayed. The image may be a video, an animation or a still image, and may be related to a content provider indicated by the selected icon or content provided by the content provider.

In operation S104, if there is an input from the user while the image is displayed, a server of the content provider of the selected icon is accessed in operation S105. If there is no input from the user, the image may be repeatedly displayed, or a plurality of different videos may be sequentially displayed. In operation S106, the initial screen of the server of the content provider is displayed, and, in operation S107, content is provided according to a service provided by a typical display device.

Hereinafter, user experience (UX) of the display device 30 will be described.

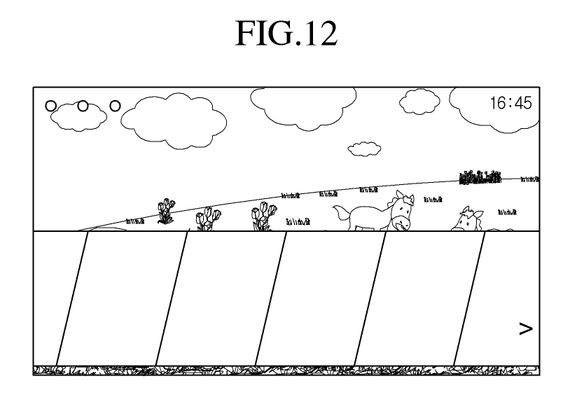

FIGS. 12 to 14 illustrate an operation of an uppermost layer of the UX.

FIG. 12 illustrates an operation for a recent list of the UX of the display device 30.

The recent list represents a list of operations most recently used by the user. In detail, the recent list represents a list of recently used applications or recent inputs to the display device 30 from the user. The contents of the recent list may be arranged in an inverse order of use. In one embodiment, the recent list may be arranged at a lower end of the screen as illustrated in FIG. 12.

In one embodiment, the recent list may be displayed as an image for an application or an input. In another embodiment, the recent list may be displayed as a text indicating a title of an application or an input. In another embodiment, in the case where there is no image or title for an application or an input, a default image stored in a display device may be displayed. The user may rapidly re-execute a frequently used application or input using the recent list.

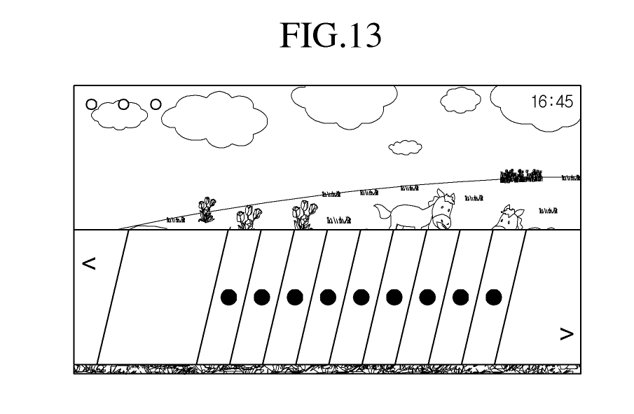

FIG. 13 illustrates a home screen of the UX of the display device 30.

The home screen displays an application preferred by the user at the lower end of the screen. In detail, the application may be displayed as an icon that is an image representing the application. If the icon does not exist, a default image may be displayed. The preferred application may include an application frequently used by the user or a premium application displayed by a contract. The home screen displays an application, an input, a setting or information preferred by the user on the background.

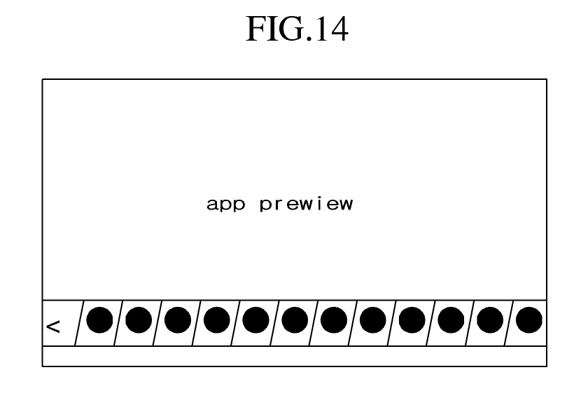

FIG. 14 illustrates a launcher screen of the UX of the display device 30.

The user may manage all sources including application and inputs using the launcher screen. For example, the user may delete an application or may move a location of an icon of the application. “app preview” displays a image provided by a developer, wherein the image may arouse interest of the user in an application. The “app preview” may be displayed on the background 213. The user may obtain basic information used for controlling an application using the “app preview”.

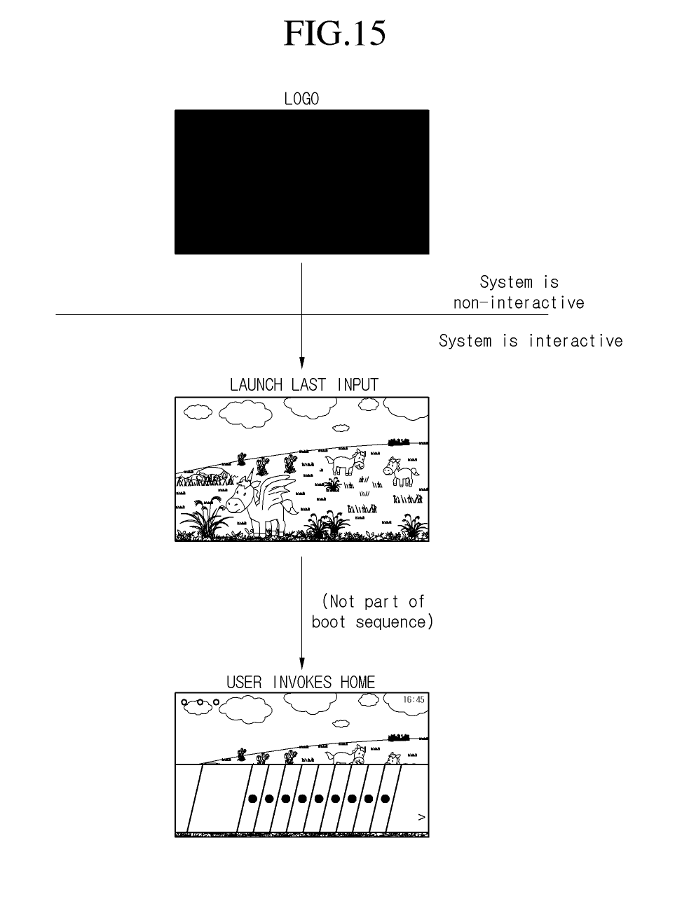

FIG. 15 illustrates a process of booting the display device 30.

A typical TV is booted in the following order: 1) pushing a power button; 2) initially displaying a logo of a manufacturer on the display unit 44 of the display device 40; and 3) launching a last input made by the user during previous use of the TV. For example, if the user lastly viewed channel 10 during the previous use of the TV, channel 10 is initially displayed on the display unit 44 when the TV is turned on.

According to the typical TV, the display device 30 prepares to interact with the user while launching the last input made by the user during the previous use of the TV. In detail, the display device 30 helps the user call the home screen and select an application or an input to be used by the user from the called home screen.

Meanwhile, in the case where there is no last input (for example, in the case where the display device 30 is initially used), a default input is launched. The default input may be changed according to an environment in which the display device 30 is manufactured.

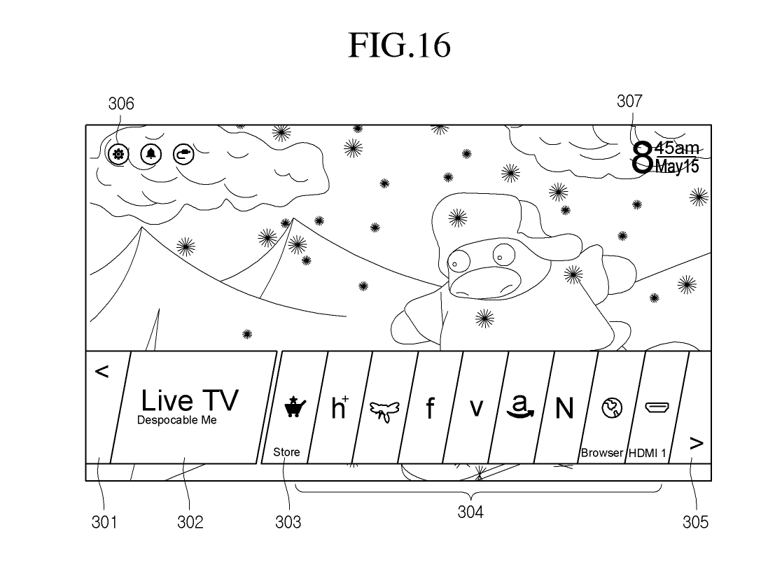

FIGS. 16 to 18 illustrate a method of manipulating the home screen. In one embodiment, the home screen may be called by pushing a home button of the remote controller 51. In another embodiment, the home screen may be called by clicking a go-back icon on the recent list or the launcher screen. In another embodiment, the home screen may be called by clicking a go-back icon at an uppermost step of an application.

FIG. 16 illustrates an overall configuration of the home screen.

The home screen includes a recent list button 301, a current display application icon 302, a store icon 303, a quick launcher 304, a launcher button 305, a global action icon 306 and a time icon 306.

The recent list button 301 switches the home screen to a recent list screen. The recent list screen displays applications or inputs recently used by the user. These applications or inputs are displayed in an inverse order of input thereof.

The current display application icon 302 displays information on a currently used application. In detail, the current display application 302 may display information on an application or an input running on the background 213. In one embodiment, the information on the application may include a title or an image. The current display application icon 302 may be updated and changed according to an input from the user.

The store icon 303 switches the home screen to an application store screen. The store icon 303 may not be displayed on the launcher screen. Furthermore, the store icon 303 may be configured so as not to be modified or deleted by the user. An application to be used by the user, except for preinstalled applications, may be detected from the application store so as to be installed in the display device 30. The application store may continuously provide updates to applications installed in the display device 30.

The quick launcher 304 may be displayed on the basis of a maximum number of applications that may be displayed on one screen. In one embodiment, the maximum number of applications may be 8. The quick launcher 304 may include a general application icon and a system icon. In one embodiment, the general application icon may be displayed with RGB color, and the system icon may be displayed in the form of an achromatic text label.

The launcher button 305 switches the home screen to the launcher screen. The global action icon 306 displays setting information, a notice and an input selection window at an upper left end of the screen. The time display icon 307 indicates a current date and time. In FIG. 16, the global action icon 306 and the time display icon 307 are displayed at the upper left end and the upper right end respectively, but the locations of the global action icon 306 and the time display icon 307 may be changed according to an intention of the user or a manufacturer environment.

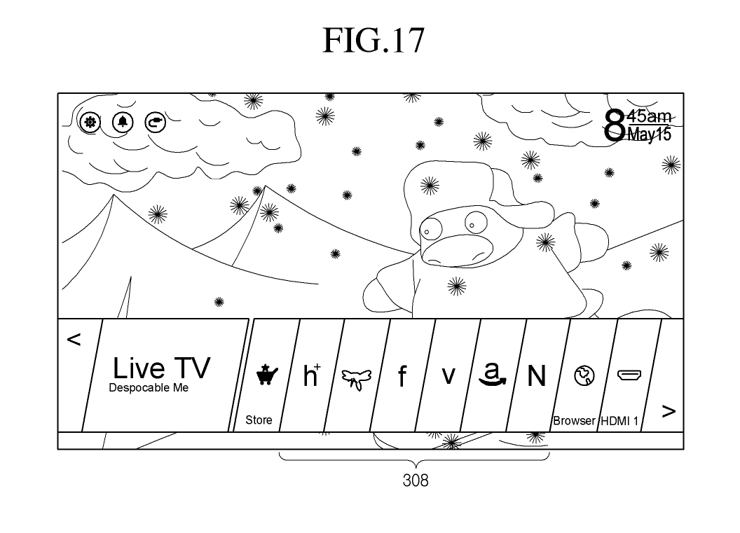

FIG. 17 illustrates that a content provider (CP) application which is a type of a general application is installed.

Referring to FIG. 17, the applications displayed on the quick launcher 304 may include a CP application (or a premium application) 308 that is preinstalled. The CP application 308 may be installed by as much as a specific number determined by contract conditions. In one embodiment, the specific number may be 6. The CP application may be built in a system area so as to be installed. The CP application, which is installed by a contract, may be displayed on the initial screen. That is, the CP application is displayed on a position easily recognizable by the user, so as to increase a frequency of use of the CP application.

The CP application is initially installed in the form a stub application. The stub application represents an application that is not completely installed to be directly used by the user, but only an outer form of the application is installed excepting an actual function of the application. In detail, an icon of the stub application is displayed on the initial screen, but a program for actually executing a corresponding application is not installed. In order to use the stub application, the user may additionally download and completely install the corresponding application.

The user may not use the CP application, but the CP application should be installed by a contract. Therefore, the CP application is initially installed in the form of a stub application which occupies a relatively less capacity of the storage device 49 of the display device 30, thereby improving the efficiency of use of the storage device 49.

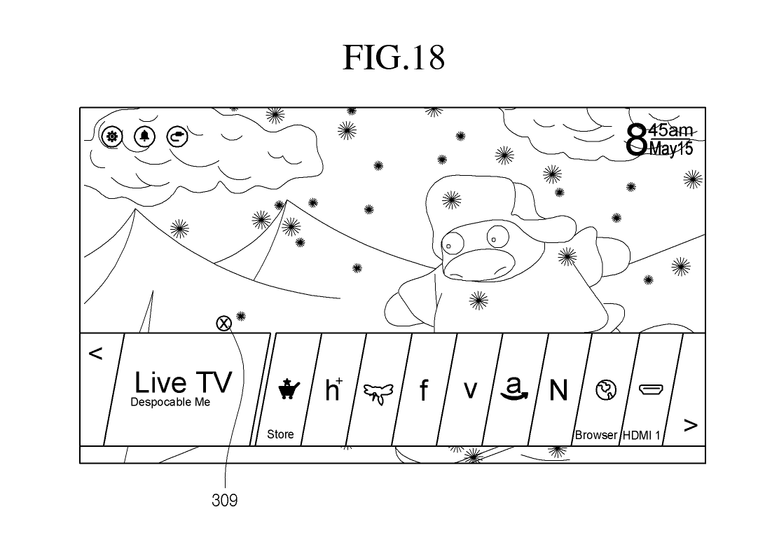

FIG. 18 illustrates that the current display application 302 is controlled on the home screen.

If the user desires to close a currently displayed image, the user may click a circular delete button 309 arranged on the current display application icon 302. When the delete button 309 is clicked, an application displayed on a current screen is closed. When the application displayed on the current screen is closed, a waiting application is launched.

In one embodiment, the waiting application may be an application that has most recently executed. In another embodiment, the waiting application may be a default application determined when being initially designed. If the user closes all applications, an operation for a last input of the user is automatically launched.

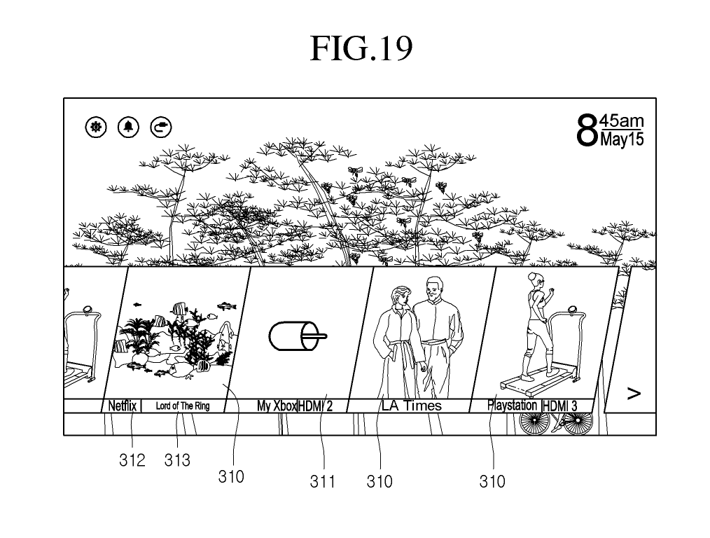

FIGS. 19 to 21 illustrate a configuration of the recent list screen.

FIG. 19 illustrates an overall configuration of the recent list screen.

The recent list screen may include a title preview 310. In one embodiment, the title preview 310 may be an image related to a title. In another embodiment, the title preview 310 may be a text related to a title.

The title preview 310 may include an application title 312. Furthermore, the title preview 310 may include a view title 313. The view title 313 may not be displayed in the case where a corresponding application does not provide the view title 313. The view title 313 may not be displayed in the case where the view title 313 is identical to the application title 312. In the case where the title preview 310 is not provided, a default image 311 stored in the storage device 49 may be displayed.

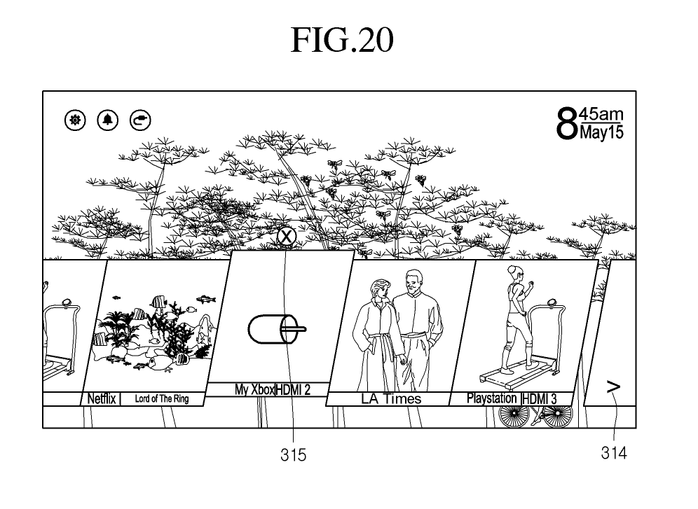

FIG. 20 illustrates that the recent list is deleted.

A delete button 315 may be present when the pointer 53 is located on a focused application. In one embodiment, the user may click the delete button 315 located on a recent list so as to delete the list. In another embodiment, the user may place the pointer 53 of the remote controller 51 on the delete button 315 and may push an OK button of the remote controller 51 so as to delete the recent list.

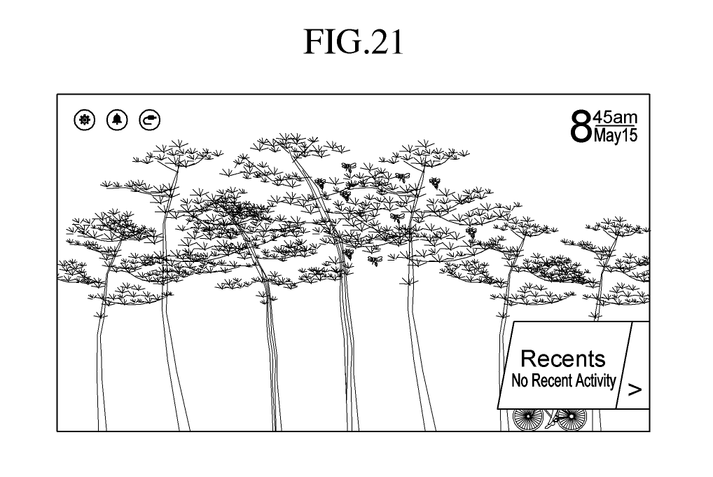

FIG. 21 illustrates a screen on which the recent list does not exist.

In the case where the recent list does not exist, an indicator indicating that the recent list does not exist may be displayed at a lower right end of the screen, as illustrated in FIG. 21. In this case, even though the pointer 53 is placed on a part where the indicator is displayed, the delete button 315 is not activated. In the case where the recent list does not exist, the recent list screen may be automatically switched to the home screen after a lapse of a certain period of time.

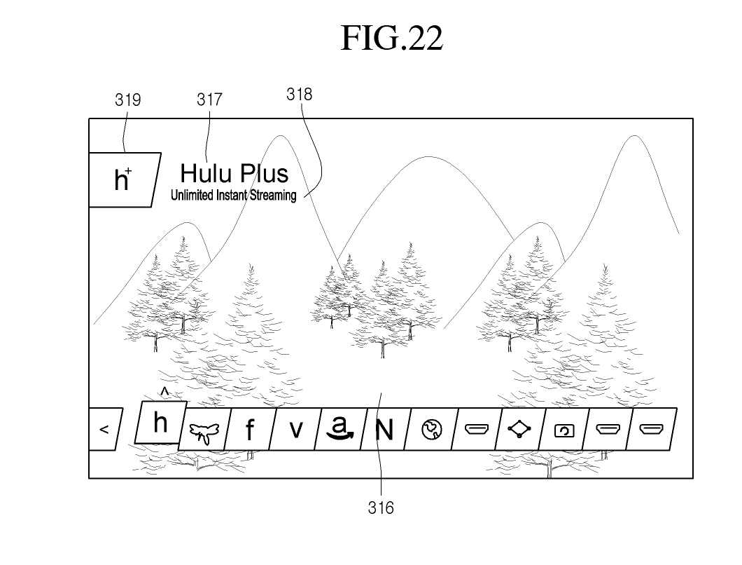

FIG. 22 illustrates an overall configuration of the launcher screen.

The user may manage or install all applications using the launcher screen. On the launcher screen, icons of applications may be arranged along a lower end of the screen and may have smaller sizes than on the home screen or the recent list screen. When the user focuses on one of the icons, an image 316 related to an application of the corresponding icon may be displayed on the background. The image 316 may be a preview of a focused application. In the case where the image 316 does not exist or is unable to be displayed, a default image stored in the storage device 49 may be displayed.

In one embodiment, a title 317 of the focused application may be displayed on the launcher screen. In the case where a subtitle 318 of the focused application exists, the subtitle 318 may be displayed under the title 317. An icon 319 of the focused application may be displayed together with the title 317. The arrangement of the foregoing images or icons illustrated in the drawing is merely an example, and thus, the images or icons may be displayed at different locations and in different forms.

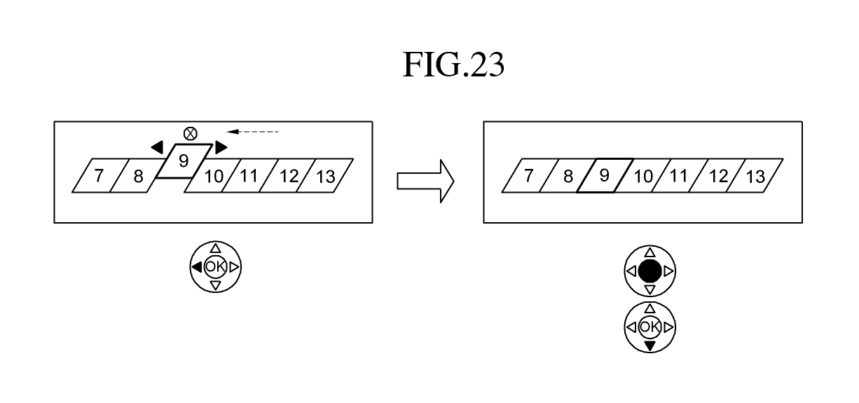

FIGS. 23 to 26 illustrate control of icons on the launcher screen. A method of controlling an icon may be classified into a method using a 5-way mode and a method using the pointer 53. According to the control method using the 5-way mode, icon control is performed using a direction key and the OK button of the remote controller 51. According to the control method using the pointer 53, the icon control is performed by issuing a command with the remote controller 51.

FIG. 23 illustrates a method of moving an icon in the 5-way mode.

In a launcher edit mode, an icon of a corresponding application becomes controllable by the user. When the icon is controllable, the icon is manipulated by pushing a left or right direction key on the remote controller 51. When the icon is positioned at a location desired by the user, the user pushes the OK button or a downward direction key of the remote controller 51 to complete movement of the icon.

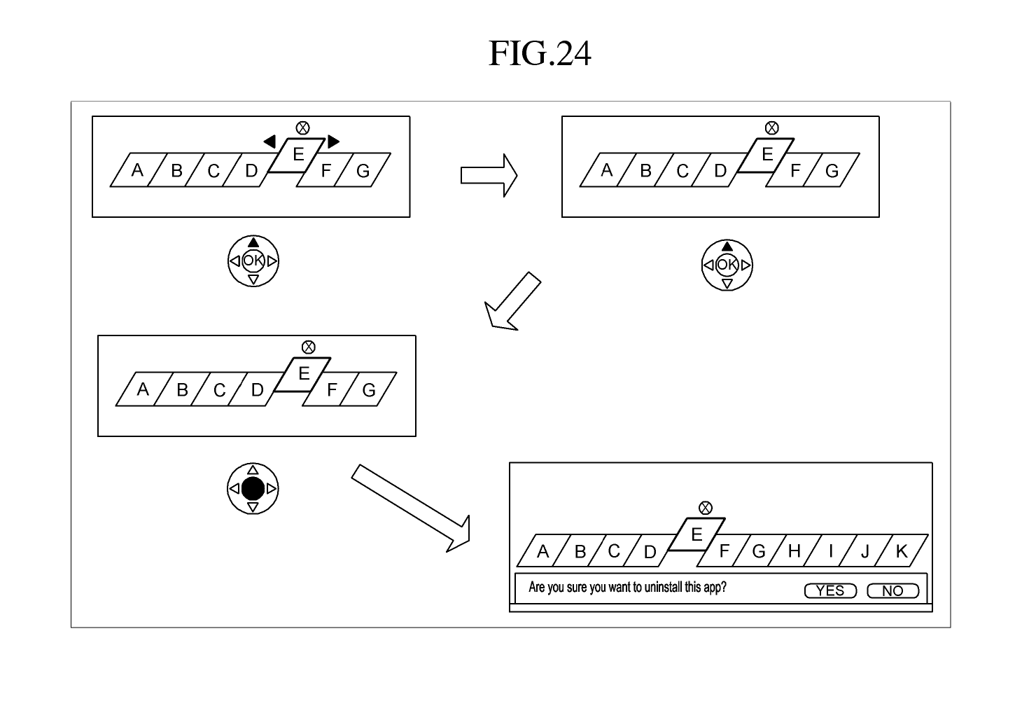

FIG. 24 illustrates a method of deleting an icon in the 5-way mode.

In the launcher edit mode, an icon of a corresponding application becomes controllable by the user. When the icon is controllable, an upward direction key of the remote controller 51 is pushed to focus on the icon. While the icon is focused, the upward direction key is pushed again. When the upward direction key is pushed again, a delete button is activated. When the delete button is activated, the OK button is pushed. When the delete button is pushed, a screen for inquiring whether to delete the focused icon is displayed. YES or NO may be selected using the direction key. If YES is selected, the icon is deleted.

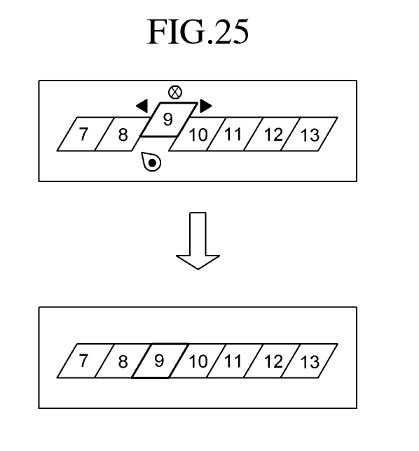

FIG. 25 illustrates a method of moving an icon in a pointer mode.

In the launcher edit mode, an icon of a corresponding application becomes controllable by the user. When the icon is controllable, the pointer 53 is moved close to the icon in order to focus on the icon. The pointer 53 may be moved to such a location as to affect the icon. When the icon is focused by moving the pointer 53, the icon is clicked to be positioned at a desired location.

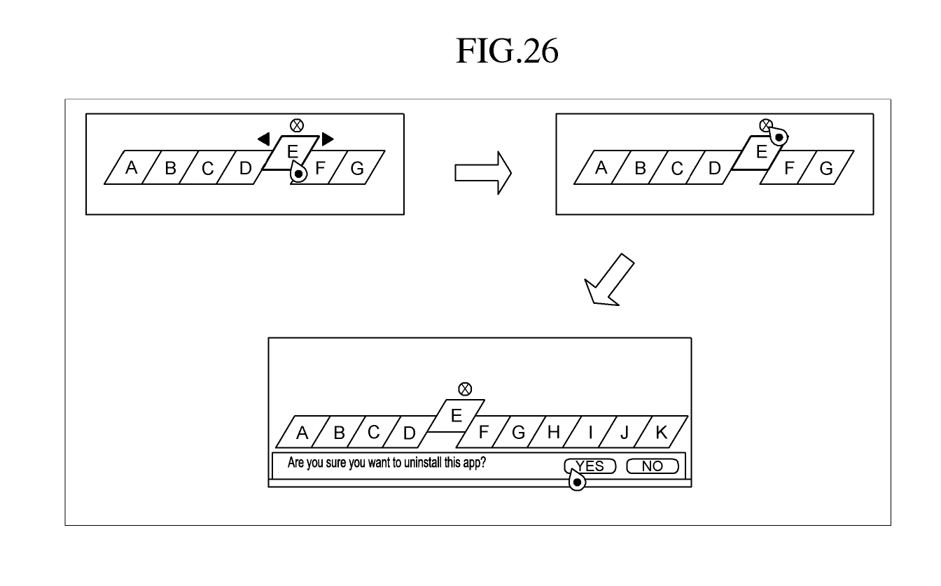

FIG. 26 illustrates a method of deleting an icon in the pointer mode.

In the launcher edit mode, an icon of a corresponding application becomes controllable. When the icon is controllable, the pointer 53 is moved close to the icon in order to focus on the icon. When the icon is focused, the pointer 53 is located on an activated delete button on the icon. The delete button is pushed by using the ENTER button or scroll wheel of the remote controller 51. When the delete button is pushed, a screen for inquiring whether to delete the focused icon is displayed. YES or NO may be selected using the pointer 53. If YES is selected, the icon is deleted.

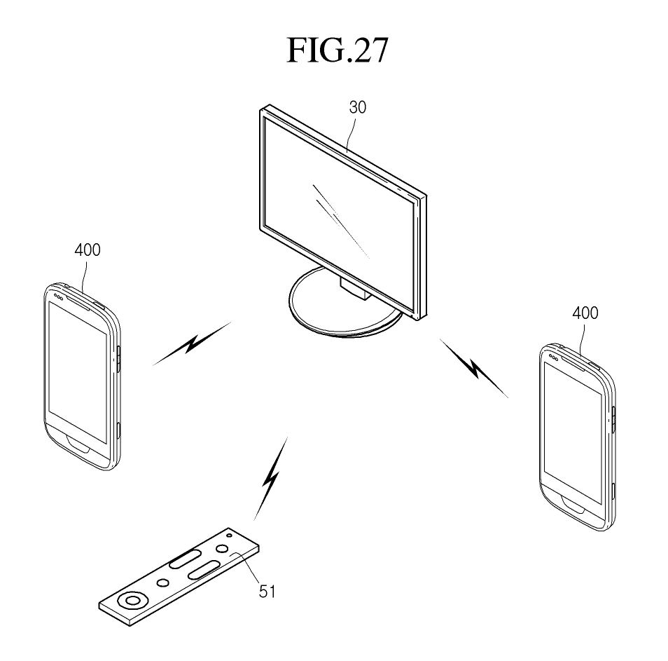

FIG. 27 illustrates the display device 30, the remote controller 51 and an external device 400 according to an embodiment. The display device 30 is basically provided, and a plurality of external devices 400 may be connected to the display device 30. When the external device 400 is connected to the display device 30, the display device 30 may be controlled by the remote controller 51.

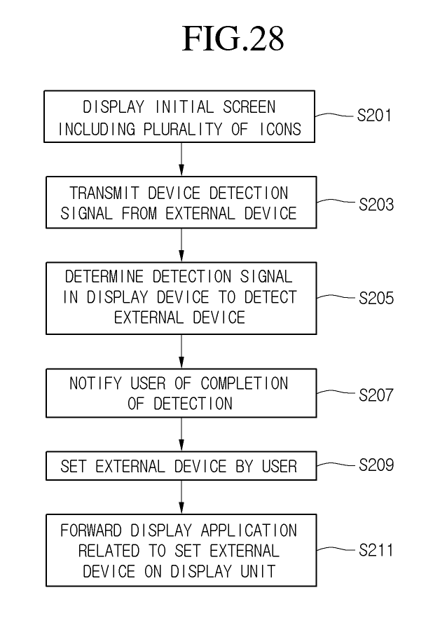

FIG. 28 is a flowchart illustrating a process of changing a location of a related icon according to connection of an external device.

An initial screen including a plurality of icons is displayed on the display device 30 (operation S201). The plurality of icons may correspond to a plurality of applications respectively. The plurality of icons may be images that represent the plurality of applications respectively. Each of the plurality of applications may be a program for controlling one of a service provided by a content provider, a display device and an external device.

In one embodiment, the display device 30 may display the icons of the applications at a lower end of the screen. For example, the icons may be arranged horizontally at the lower end of the screen. The icons may be displayed in a text form or may be expressed by RGB color.

In the case where the number of the icons is not smaller than a specific number, the display device 30 may display the icons on different pages. For example, eight icons may be arranged on one screen, and a ninth icon and following icons may be displayed on a second page. In one embodiment, the icons may be displayed from left to right.

The display device 30 receives a detection signal from the external device 400 (operation S203).

When the external device 400 is physically connected to the display device 30, the display device 30 receives the detection signal from the external device 400. In one embodiment, the external device may be one of a set-top box, a game machine and a mobile terminal, or may be any device that may be used in combination with a display device.

In one embodiment, the external device 400 may transfer a unique signal to the display device 30. In detail, the unique signal may be an ID of a device. For example, the unique signal may be a serial number of an external device.

When the connection between the external device 400 and the display device 30 is established, the external device 400 may automatically transfer the detection signal so as to notify the display device 30 that the external device 400 is connected thereto. In one embodiment, information on whether to set a set-top box may be transferred through an internal application of the display device 30. For example, the internal application may include a device connector.

The control unit 50 of the display device 30 detects the external device 400 using the detection signal transferred from the external device 400 (operation S205).

In one embodiment, the control unit 50 of the display device 30 may detect the external device 400 using an application. For example, the control unit 50 of the display device 30 may use an input hub application installed in the display device 30 so as to detect the external device 400 on the basis of a change of a setting of the external device. In the case where a TV is unable to automatically detect a setting of a game machine or a DVD player other than a set-top box, among the external devices 400, the input hub application receives, from the user, an input about modification so as to change information on an external input device connected to the TV.

In another embodiment, the set-top box may be detected using a module installed in the display device. In detail, a setting of the set-top box may be detected using an IRDB manager installed in the display device. The IRDB manager may provide a list of connected external devices to the user, and may store setting information received from the user in a database.

The detection of the set-top box will be described in more detail. When the set-top box is initially connected to the display device, an external input manager (EIM) detects information indicating that the set-top box is connected to a specific connection terminal. The EIM detects information on an external device connected to the display device in a hardware level. Therefore, the EIM may detect what device is currently connected to a specific terminal, but may not detect specific characteristics or setting information of the device.

When the information indicating that the set-top box is connected to the specific terminal is received through the EIM, a first use or device connector application provides a screen for receiving setting information from the user. The user may input detailed information (e.g., a manufacturer) on the set-top box through the screen.

The setting information received from the user is stored in the database. Thereafter, the control unit 50 may change an order of icons on the screen using the stored set-top box setting information.

In another embodiment, when an external device is connected using HDMI equipment, the display device may automatically detect the external device on the basis of electric signals exchanged with the external device. In detail, the electric signals exchanged using the HDMI may have a region containing information on the external device, and the display device 30 may interpret the information so as to automatically detect the external device 400 currently connected thereto. The signal for the information on the external device may be a protocol complying with a specific regulation. The control unit 50 detects the connected external device 400 and prepares to use the external device 400.

When the display device 30 completes detection of the external device 400, the control unit 50 notifies the user of the completion of the detection (operation S207).

In one embodiment, the control unit 50 may display a completion message on the display unit 44 so as to notify the user of the completion of the detection. In another embodiment, the control unit 50 may acoustically notify the user of the completion of the detection using an audio output unit 185 For example, a recorded voice for the completion may be output to the user. For another example, a unique sound indicating the completion may be output to the user.

The display device 30 receives a setting completion signal from the external device 400 (operation S209).

In one embodiment, the setting completion signal may be related to completion of installation of an external device. In another embodiment, the setting completion signal may be used so as to notify the display device 30 that the user has completed setting of the external device 400. The display device 30 may recognize that the setting of the external device 400 has been completed, by virtue of the setting completion signal.

In one embodiment, the setting of the user may be initially installing the set-top box and connecting the set-top box to an external device. In another embodiment, the setting of the user may be modifying a table of channels received by the set-top box. In detail, the table of channels may be modified such that preferred channels remain and non-preferred channels are deleted. In another embodiment, the setting of the user may be related to operation of a game machine. When the user sets the external device 400, the control unit 50 may determine that the user intends to use the external device 400.

Upon receiving the setting completion signal from the external device 400, the control unit 50 automatically forward arranges an icon of an application required for operating the external device 400 (operation S211).

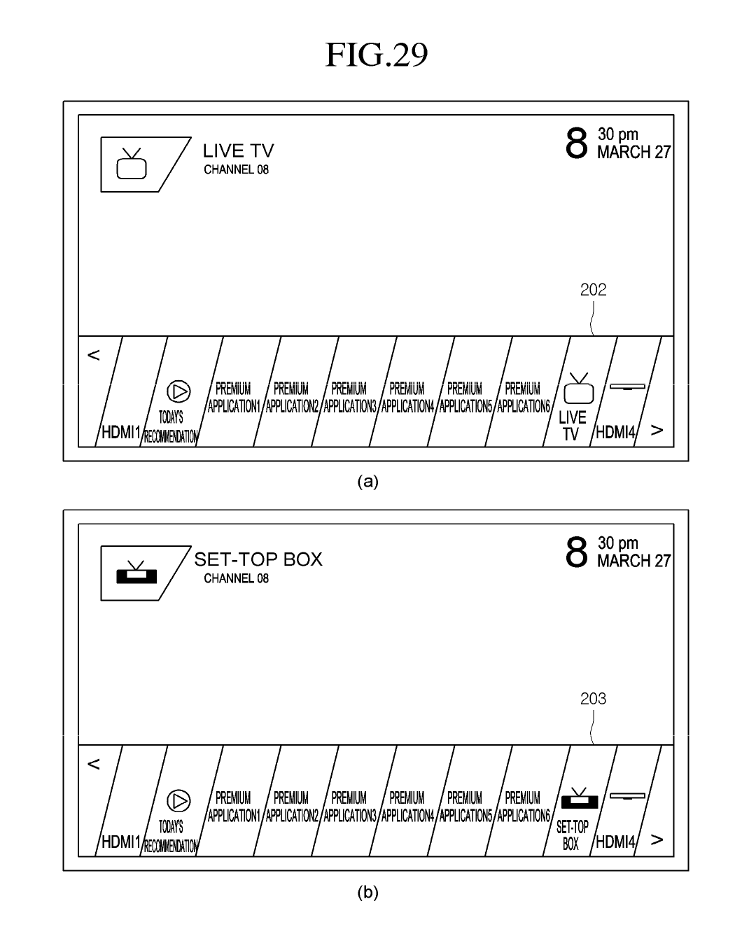

This operation will be described with reference to FIG. 29.

FIG. 29 is a diagram illustrating that the control unit 50 automatically forward arranges an icon related to the use of the external device 400.

Referring to FIG. 29A, an initial screen is displayed on the display unit 44 of the display device 30. In one embodiment, in the case where the set-top box is initially installed, a set-top box application may be installed in the display device. When the set-top box application is installed, the display device may generate and display an icon of the set-top box application. However, when the set-top box is initially installed, the icon of the set-top box application is arranged at a lowest priority position. This is because an order of arrangement of icons is determined according to an order of installation, unless otherwise controlled.

As illustrated in FIG. 29, the initial screen does not display an icon 203 related to the set-top box but displays an icon 202 related to a live TV. Therefore, the user may need to switch pages of an icon list in order to discover and manipulate the set-top box icon 203, and thus may experience inconvenience. Moreover, if the user is not familiar with a smart TV, the user may mistakenly manipulate the live TV icon 202 instead of the set-top box icon 203.

Therefore, in the case where the user sets the external device 400, the control unit 50 of the display device 30 may determine that the user intends to use the external device 400, so as to display the icon of the external device 400 on a first page of the home screen.

According to an embodiment, in the case where the user sets the set-top box, the control unit 50 may forward arrange the set-top box icon 203 at a column where icons are arranged so that the set-top box icon 203 is displayed on the first page. In another embodiment, the control unit 50 may display the set-top box icon 203 at an arbitrary position where icons are displayed within the screen. In another embodiment, when the set-top box is connected, the control unit 50 may automatically switch the live TV icon 202 to the set-top box icon 203.

In another embodiment, when the set-top box is connected, the control unit 50 may not change the live TV icon 202, and then may allow the set-top box to be operated if the user executes the live TV icon 202. In detail, when the set-top box is connected to the display device 30, the control unit 50 may determine that the user does not intend to view a live TV, may maintain the icon 202 of a live TV application and may change an execution program to a program of a set-top box application.

In another embodiment, when the set-top box is connected, the live TV icon may be manually changed to the set-top box icon by the user.

The above-mentioned embodiments may resolve the inconvenience that may be experienced by the user while switching pages to discover an icon related to the external device 400.

FIG. 29B illustrates that the icon 202 of the live TV application is not present on the first page, and the icon 203 of the application of the set-top box set by the user is displayed on the first page. In another embodiment, the icon 203 of the set-top box application may be displayed at a left end of an icon display bar of the bottom of the screen.

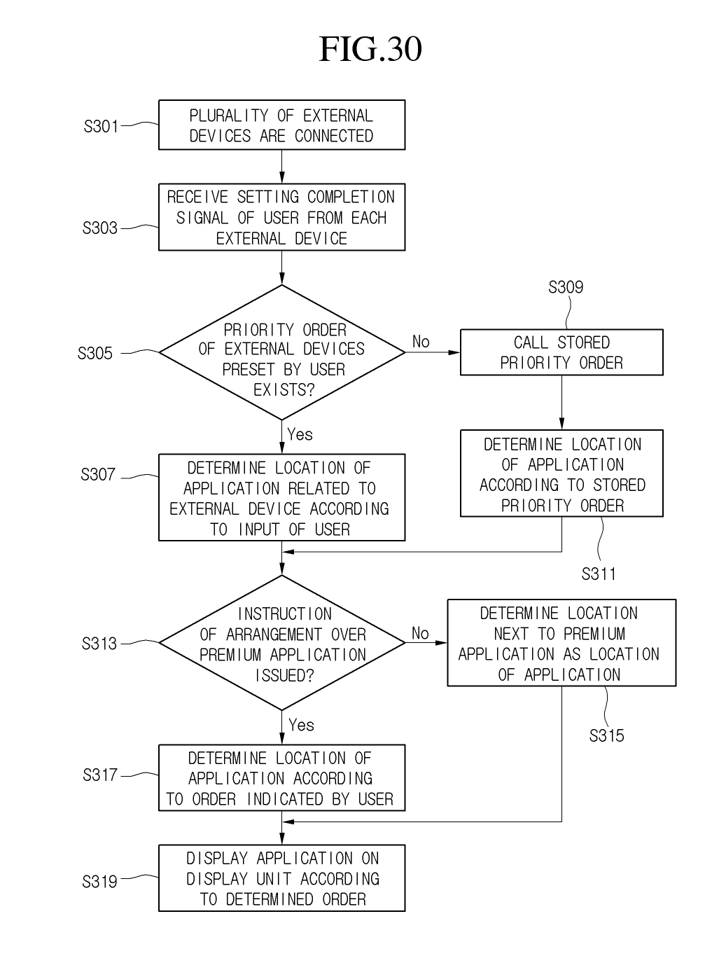

In another embodiment, in the case where the plurality of external devices 400 are connected to the display device 30, arrangement of icons of applications may become an issue. This issue will be described with reference to FIGS. 30 to 32.

FIG. 30 is a flowchart illustrating a process of arranging icons of applications when the plurality of external devices 400 are connected simultaneously to the display device 30.

The display device 30 is connected to the plurality of external devices (operation S301).

When the plurality of external devices 400 are connected, the display device 30 receives the setting completion signal from each external device (operation S303). In one embodiment, the user may set a channel of the set-top box. At the same time, the user may set a manipulation method of a game machine. When the user completes setting of the external device 400, the user pushes a confirmation button for the completion of the setting. The external device 400 receives a setting completion confirmation signal and transfers the signal to the display device 30. The display device 30 may detect whether the external device is set and the setting of the external device is completed, on the basis of the setting completion confirmation signal.

The control unit 50 of the display device 30 determines whether a priority order for the plurality of external devices 400 set by the user is input (operation S305). In detail, applications respectively related to the plurality of external devices 400 may exist, and an order of displaying icons of the applications on the display unit 44 may need to be determined. In one embodiment, in the case where two external devices 400 are connected to the display device 30, the display device 30 may inquire of the user which one of icons of applications of the external devices 400 should be arranged preferentially.

In one embodiment, in the case where three or more external devices 400 are connected to the display device 30, the display device 30 may sequentially inquire an order of arranging icons of applications of the external devices 400 from the user. For example, the display device 30 may inquire about an icon that should be arranged most preferentially, and then may inquire about an icon that should be arranged second most preferentially. Meanwhile, the display device 30 may not inquire about an icon to be arranged lastly, and may automatically arrange the last icon.

In the case where the user inputs the order of arranging the icons of the applications of the external devices 400, the display device 30 determines locations of the icons of the applications on the display unit 44 according to the input order (operation S307).

On the contrary, in the case where the user does not input the order of arranging the icons of the applications of the external devices 400, the display device 30 calls a priority order stored in a storage unit of the display device 30 (operation S309). In detail, the display device 30 may call data containing an order of arranging the icons of the applications of the external devices 400, wherein the data is preset in the storage device 49.

In one embodiment, a preset priority order may be established when the display device 30 is initially designed in consideration of usage habits of general users of the display device 30. In another embodiment, the preset priority order may be established according to habits of the user observed when the user initially uses the display device 30.

In another embodiment, the preset priority order may be automatically established on the basis of a frequency of use of each external device 400 calculated by the control unit 50. In detail, the control unit 50 may count the number of times of use of each external device whenever each external device is used, and, if the counted numbers are not smaller than a certain number, the control unit 50 may set the priority order so that the icons are arranged in descending order of the counted numbers.

For example, if the user uses the set-top box seven times in combination with the display device 30, uses the game machine three times in combination with the display device 30 and uses a terrestrial service once using the display device 30, for a month, the control unit 50 may automatically set the priority order so that the icon of the application of the set-top box has a highest priority, the icon of the application of the game machine has a second highest priority, and the icon of the application of the terrestrial service has a lowest priority.

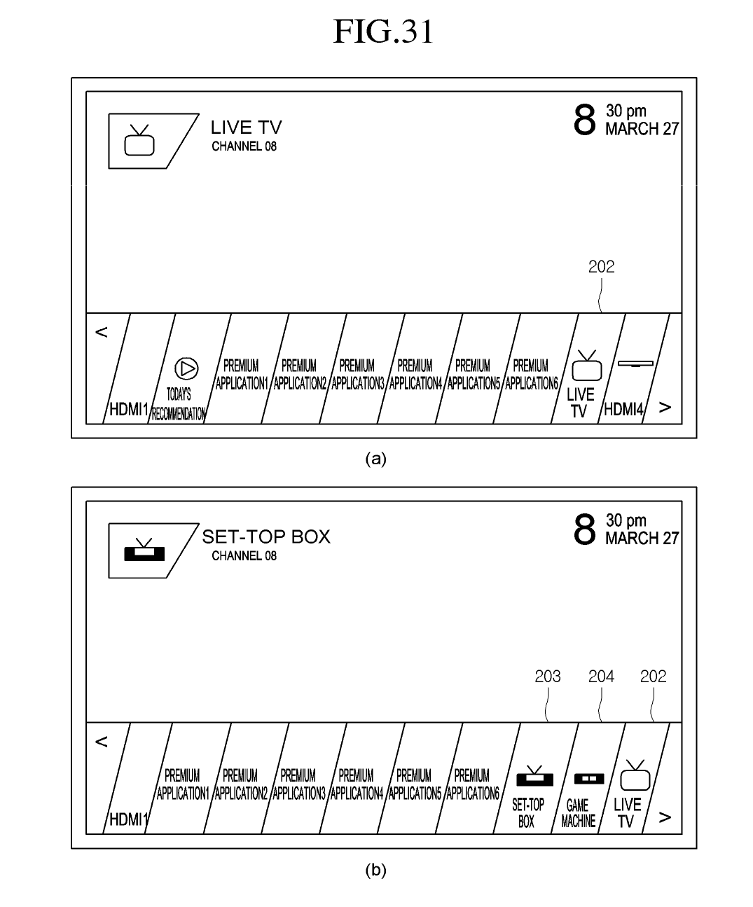

The control unit 50 determines the locations of the icons of the applications of the external devices 400 according to the preset priority order (operation S311). Arrangement of icons according to the priority order will be described with reference to FIG. 31.

FIG. 31 illustrates that icons are arranged according to the priority order when the plurality of external devices 400 are connected.

FIG. 31A illustrates that icons are initially displayed on the display unit 44 of the display device 30. Here, the icon 202 of the live TV may be displayed on the initial screen. According to an embodiment, when the plurality of external devices are connected to the display device, the control unit 50 determines an order of the icons of the applications of the external devices according to the priority order, and arranges the icons according to a result of the determination.

Referring to FIG. 31B, it may be understood that the priority order is set as an order of a set-top box, a game machine and a live TV. In detail, it may be understood that the icon 203 of the application of the set-top box having a highest priority order is arranged most preferentially, the icon 204 of the application of the game machine having a second highest priority order is arranged next, and the icon 202 of the live TV having a lowest priority order is arranged lastly. The priority order of FIG. 31 is merely an example, and may be changed according to a situation or a setting of the user.

However, even though locations of icons of applications are determined as described above, it is difficult to automatically arrange the icons with preference over premium applications that are most preferentially arranged due to a contract. Here, the premium applications represent applications that are installed according to a contract between a content provider and the manufacturer of the display device 30. The premium applications are most preferentially arranged on the screen according to the contract so that the user may easily use the premium applications. That is, since the user may easily use the premium applications, a frequency of use of the premium applications is increased, and thus, profits from content is increased.

However, the user may desire that the applications of the external devices 400 be arranged with preference over the premium applications. In detail, according to the usage habit of the user, the application 102 of the set-top box may be more frequently used than the premium applications.

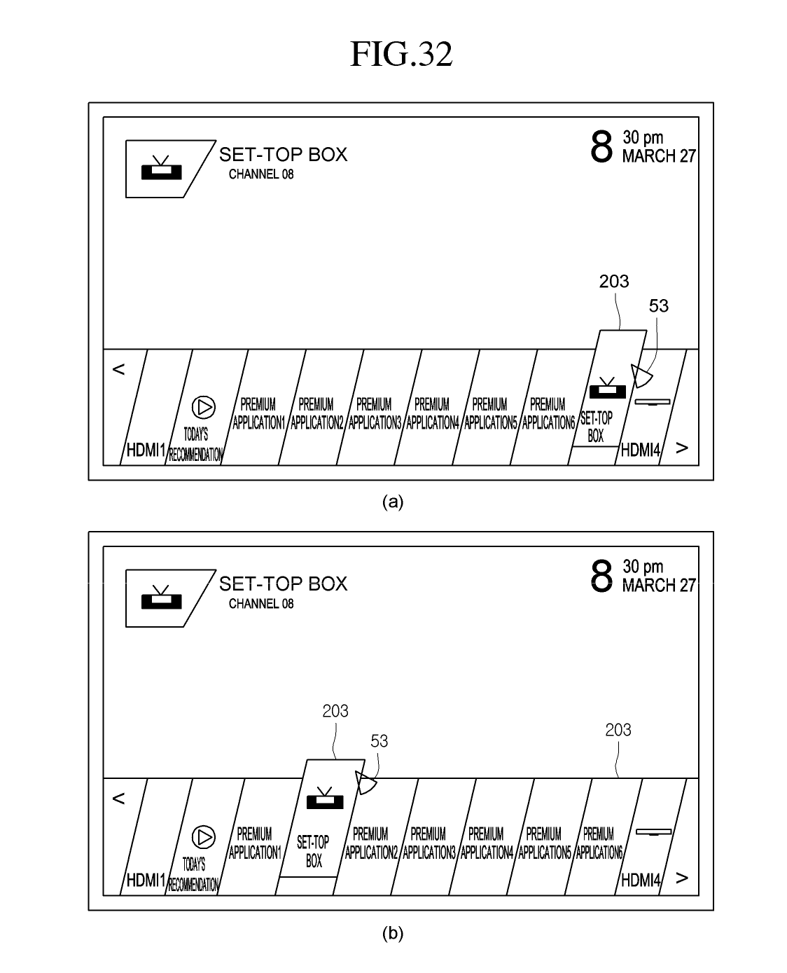

Therefore, in addition to the application arrangement order determined in operation S311, the control unit 50 determines whether the user has issued an instruction to arrange the applications of the external devices 400 with preference over the premium applications (operation S313). In one embodiment, the instruction of the user may be issued using the remote controller 51. This instruction will be described in detail with reference to FIG. 32.

FIG. 32 illustrates that the user arranges the applications of the external devices 400 with preference over the premium applications.

Referring to FIG. 32A, the pointer 53 indicates the icon 203 of the application of the set-top box by the remote controller 51. If the user desires to move the icon 203 with preference over the premium applications, the user may move the icon 202 using the remote controller 51. In detail, in an edit mode, the user may drag the icon 203 using the pointer 53 so as to move the icon 203. In one embodiment, the icon 203 may be arranged between the premium applications. In another embodiment, the icon 203 may be arranged at a left end of an icon page located at the bottom of the screen, with preference over all icons.

FIG. 32B illustrates that the user has moved the icon 203 of the application of the set-top box. When the icon 203 is moved, the premium applications may be moved backwards.

Description will continue referring back to FIG. 30.

In the case where the user has not issued the instruction to arrange the applications of the external devices 400 with preference over the premium applications, the control unit 50 determines a location next to the last premium application as a location of the application of the external device (operation S315). In one embodiment, the number of the premium applications may be 6. In this case, the application of the external device 400 may be positioned at a seventh location on the initial screen.

Meanwhile, in the case where the user has issued the instruction to arrange the applications of the external devices 400 with preference over the premium applications, the control unit 50 determines locations of the applications of the external devices 400 according to an order designated by the user (operation S317). In one embodiment, the control unit 50 may arrange the application of the external device 400 at a first location on the initial screen.

The control unit 50 arranges the applications of the external devices 400 on the display unit 44 of the display device 30 according to a determined order (operation S319).

According to an embodiment, a user interface screen may be provided on the basis of a state of connection to an external device for controlling operation of the display device 30.

According to an embodiment, the above-mentioned method may be implemented as processor-readable codes in a program-recorded medium. A processor-readable recording medium includes, for example, a ROM, a RAM, a CD-ROM, a magnetic tape, a floppy disk, and an optical data storage device, and may also be implemented in the form of a carrier wave (for example, transmission via the Internet).

The above-mentioned display device 30 is not limited to the configuration and methods of the above-mentioned embodiments. The entirety or part of the embodiments may be selectively combined with each other to make various medications.

According to various embodiments, an application related to an external device set by a user is arranged on an initial screen so that the user may efficiently controls functions of a display device.

Furthermore, according to an embodiment, when there exist a plurality of external devices set by the user, related applications are automatically arranged according to a priority order so that the user may efficiently control the functions of the display device.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for operating a display device, comprising:
displaying an initial screen comprising a plurality of icons corresponding to a plurality of applications respectively;
detecting at least one external device;
receiving, from the external device, a setting completion signal indicating that setting of the detected external device is completed; and
displaying, on the initial screen, an external device icon corresponding to the external device according to the setting completion signal.

2. The method according to claim 1, comprising:
receiving an input about a change of a display location of the external device icon; and
changing the display location of the external device icon according to the received input.

3. The method according to claim 1, wherein
the detecting at least one external device comprises detecting a plurality of external devices, wherein
the displaying on the initial screen comprises displaying, on the initial screen, a plurality of external device icons corresponding to the plurality of external devices respectively on the basis of a priority order.

4. The method according to claim 3, wherein the priority order is set by a user or is a prestored priority order.

5. The method according to claim 4, wherein the prestored priority order is stored when the display device is initially designed.

6. The method according to claim 4, wherein the prestored priority order is determined on the basis of the number of times of setting of the external device.

7. The method according to claim 6, wherein an order of displaying the icons is determined in descending order of the number of times of setting.

8. A display device comprising:
a display unit configured to display an initial screen comprising a plurality of icons corresponding to a plurality of applications respectively;
an external signal input unit configured to receive a detection signal and a setting completion signal from an external device;
a user interface unit configured to receive an input for setting locations of the icons; and
a control unit configured to control the display unit so that the display unit displays an external device icon corresponding to the external device on the initial screen according to the setting completion signal.

9. The display device according to claim 8, wherein the control unit displays the external device icon on the basis of a priority order, when the display device is connected to a plurality of external devices.
